(19) United States
(12) Patent Application Publication
(10) Pub. No.: US 2026/0222298 A1
(43) Pub. Date: Jul. 30, 2026

(54) NETWORK POLICY GENERATION USING KNOWLEDGE GRAPHS AND GENERATIVE MODELS

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,207

(22) Filed: Jan. 28, 2025

(51) Int. Cl. H04L 41/0894; G06N 5/02; H04L 41/16

(52) U.S. Cl. CPC H04L 41/0894; G06N 5/02; H04L 41/16

(57) ABSTRACT

Policy generation and/or implementation in networks including open radio access networks (O-RAN) is disclosed. A radio intelligent controller (RIC) is configured with models to facilitate automatic policy generation. In one example, a policy intent is mapped to an imperative objective by a first model. Data retrieved from a knowledge graph, which knowledge graph is updated by a second model, is augmented with the imperative objective to generate a prompt. A third model, which also received the network's telemetry data, generates a recommended policy for implementation in the network.

### TECHNOLOGICAL FIELD OF THE DISCLOSURE

Embodiments disclosed herein generally relate to generating and/or implementing policies in networks including radio access networks (RANs) and open radio access networks (O-RANs). More particularly, at least some embodiments relate to systems, hardware, software, computer-readable media, and methods for model-based automated policy generation and/or implementation for networks including RANs and O-RANs.

### BACKGROUND

Policies in in networks such as O-RANs and RANs are often used to govern or control network related operations. Policies allow the networks to adapt to changing circumstances in the networks. However, conventional policy generation and implementation is semi-static. More specifically, the process of generating and/or updating policies in a network is manually performed by network engineers. While these engineers are skilled, the ability to response to real-time network changes is costly and limited due to the nature of the work. Consequently, conventional approaches to policy generation and/or policy implementation are unable to adapt to the dynamic nature of a network, which results in inefficiencies and a limited ability to adapt to changing network conditions.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of a policy generation engine to include in or associate with a radio intelligent controller (RIC) of a network such as an open radio access network (O-RAN);

FIG. 1B discloses aspects of a network such as an O-RAN network;

FIG. 2 discloses aspects of a radio intelligent controller (RIC) configured to perform policy management operations, which includes generating and/or updating policies;

FIG. 3 discloses aspects of a method for performing policy management; and

FIG. 4 discloses aspects of a computing device, system, or entity.

### DETAILED DESCRIPTION OF SOME EXAMPLE EMBODIMENTS

Embodiments disclosed herein generally relate to policy management and policy management operations in networks. More particularly, at least some embodiments relate to systems, hardware, software, computer-readable media, and methods for policy management, which includes policy generation and/or policy implementation, in networks including open radio access networks (O-RANs).

Embodiments of the invention more specifically relate to automated policy generation and/or policy implementation in a network. Embodiments of the invention are discussed in the context of O-RANs (e.g., telecommunication networks), but are applicable to wireless and/or wired networks. Embodiments of the invention are configured to generate, update, and/or implement network policies in an automated manner and in a manner that accounts for the dynamic nature of the O-RAN.

Embodiments of the invention reduce or eliminate the need for network engineers to manually perform policy management in the O-RAN. Embodiments of the invention relate to a radio intelligent controller (RIC) provisioned with or having access to one or more agentic foundation models (AFMs) (or Large Language Models) that allow policies to be generated and implemented in an automated manner.

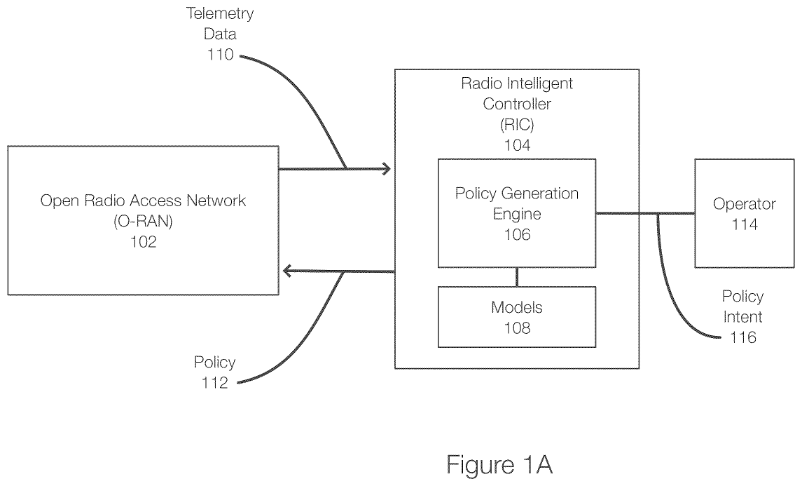

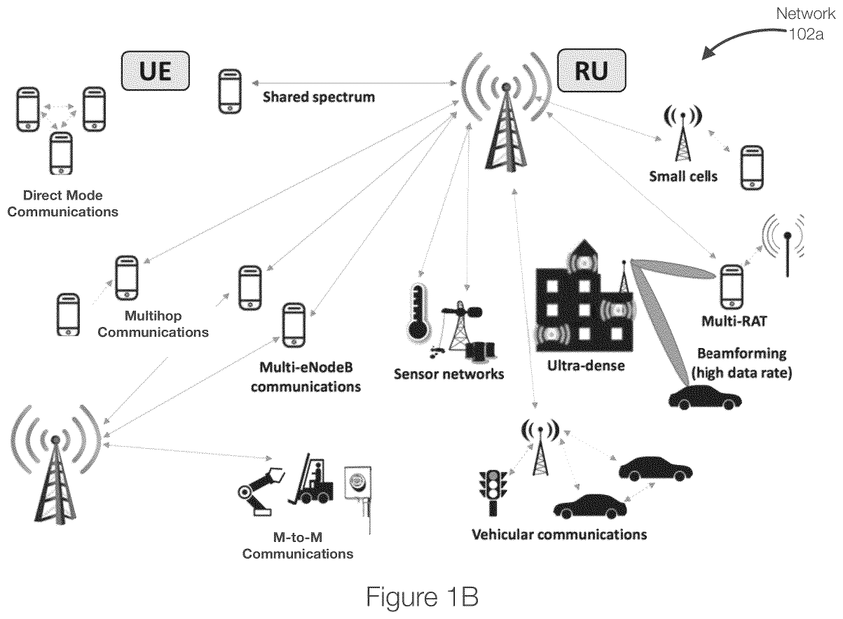

FIG. 1A discloses aspects of an RIC associated with an O-RAN or network 102. In this example, the RIC 104 includes or is associated with a policy generation engine 106 that includes or has access to models 108 (e.g., AFMs, LLMs). The RIC 104, or more specifically the policy generation engine 106, may receive a policy intent 116 (e.g., a request) from an operator 114, which may be a network user/administrator or an AI agent. The policy generation engine 106 is configured to automatically generate a policy 112 based on the policy intent 116 and apply the generated policy, which may be an update to an existing policy, to the network 102. More specifically, the models 108 may have access to data, which may include telemetry data 110 of the network, and the policy generation engine 106 works with the models 108 and the policy intent 116 to generate a policy 112 that is applied to the network 102.

Generally, an O-RAN is an example of a RAN that includes an open, flexible and interoperable architecture. An O-RAN may use standardized interfaces thereby providing flexibility. Generally, an O-RAN includes various types of components including: radio units, distributed units, and centralized units, each performing various operations in the O-RAN. From a general perspective of a network protocols, the radio units are associated with the physical layer, the distributed units are associated with lower layers of the network, and the centralized units are associated with the higher layers of the network.

FIG. 1B discloses aspects of a network such as an O-RAN. FIG. 1B illustrates a network 102a, which is an example of the network 102 and an example of an O-RAN network. In this example, the network 102a includes towers, small cells, user equipment, multihop communications, multi-enodeB communications, sensor networks, vehicular communications, M-to-M communications, ultra-dense networks multi-RAT, beamforming, and the like. Each of these components may represent or include radio, distributed, and/or centralized units.

FIG. 1B illustrates the complexity of the network 102a. Embodiments of the invention, which relate to the automated generation and/or implementation of policies, allows the functions and operations of the network 102a to be adapted or changed dynamically in response to changing network dynamics.

Returning to FIG. 1A, the network 102 is associated with and/or controlled by policies of various types. Example policies include, by way of example only, load balancing policies that are configured to distribute traffic in the network 102 and prevent congestion, energy related policies that may be configured to conserve energy (e.g., by switching components such as radios to low-power modes), radio interference related policies that may be configured to prevent or reduce radio interference, quality of service policies (e.g., latency policies), security policies such as encryption, mobility policies (handover policies for moving users), frequency band policies, resource allocation polices, and the like or combinations thereof.

Some of these policies may be configured to address existing conditions and help ensure that the network 102 is operating efficiently, securely, and the like. Because conditions in the network may change, it may also be necessary to generate policies, which may include updating existing policies.

There are many different scenarios that may occur in a network that may benefit from a policy change or update and the ability of embodiments of the invention to generate policies in an automated manner allows the network to respond to changing conditions more quickly and more dynamically. For example, a concert or sporting event may place a burden on a particular tower or cell. If a performance drop is detected due to the event or in anticipation of the event, a request may be generated to generate a load balancing policy for towers that may be impacted by the event. The request to generate a load balancing policy is an example of a policy intent 116. The policy generation engine 106, which may be receiving telemetry data 110 from the network 102, can generate a policy that may shift traffic from one tower to another tower, limit users, or the like, in order to perform load balancing. This type of policy can be generated and implemented in real-time or near real-time such that a solution is delivered with meaningful and useful timing (e.g., before the event or while the event is still occurring).

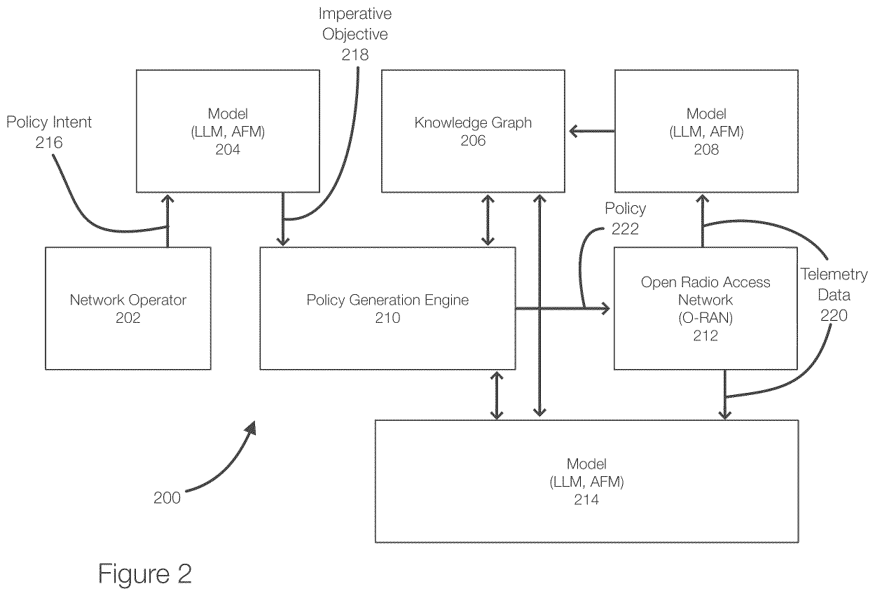

FIG. 2 discloses aspects of an RIC for a network such as an O-RAN. In this example, an RIC 200 is associated with the network 210. The RIC 200 includes an network operator 202 (which may be a user or an AI agent), a model 204, a model 208, a model 214, a knowledge graph 206, and a policy generation engine 210. The models 204, 208, and 214 may be trained or fine-tuned using different data and may be configured for different purposes that are related to policy management in the network 212. Although aspects of embodiments of the invention are performed by the models 204, 208, and 214, these aspects can be viewed as being performed by the policy generation engine in some examples.

More specifically, the network operator 202 may send a policy intent 216 (e.g., a prompt or declarative objective) to a model 204. The network intent 216 may be expressed in natural language (e.g., perform load balancing at towers at a particular location). The model 204 is configured (trained) to map the policy intent 216 into an imperative objective 218, which is provided to the policy generation engine 210. More specifically, the model 204 converts or maps the policy intent 216 into an imperative objective 218 that is suitable for the policy generation engine 210. For example, the policy intent 216, which is an example of a declarative objective, allows the network operator 202 to specify a policy (e.g., a goal) without detailing the steps or operations required to achieve the goal or policy. The model 204 maps the policy intent 216 to an imperative objective 218, which specifies the steps or operations to perform to achieve the policy intent 216.

For example, the policy intent 216 or declarative objective may be: “Ensure sufficient resources for the IoT network slice based on device connectivity.” This intent may be mapped to an imperative objective 218 of: “Allocate additional resources to the network slice handling IoT devices when the number of connected devices exceeds 1000.”

Another example of the model 204 mapping a policy intent 216 to an imperative objective 218 is: Policy Intent: “Maintain efficient CPU usage across all network nodes.” This is mapped to an imperative objective 218 of :Imperative Objective: “Monitor the CPU usage of all network nodes every 5 minutes and alert if usage exceeds 80%.”

As further illustrated in FIG. 2, telemetry data 220 of the network 212 is provided to the model 208 and to the model 214. The telemetry data 220 may include measurements of values in the network 212, current conditions in the network 212, or the like. For instance, the telemetry data 220 may include signal strength (received/transmitted), latencies, load, bandwidth consumption, or the like. More generally, the telemetry data 220 may include signal metrics, transmission metrics, resource usage, hardware characteristics (e.g., temperature, power consumption, hardware status), or the like. Other telemetry data 220 may include packet error rates, throughput, data flow, network health, session statistics, or the like. The telemetry data 220 may include data at a network-level, a controller (RIC) level, a security level, an energy efficiency level, a device or end-user level, or the like or combination thereof.

In one example, the telemetry data 220 may include signal strength and quality data such as measurements of signal-to-noise ratio (SNR), received signal strength indicator (RSSI), and bit error rate (BER), network traffic statistics such as data on throughput, latency, jitter, and packet loss, resource utilization metrics such as CPU, memory, and bandwidth usage of network elements, user mobility data such as information on user device locations, handovers, and mobility patterns, interference level data such as measurements of co-channel and adjacent-channel interference, and energy consumption data such as power usage statistics of network components.

The model 208 is configured to receive the telemetry data 220 and update a knowledge graph 206 of the network 212. Thus, the telemetry data 220 can be used to update the relevant nodes and edges in the knowledge graph 206. For example, a radio unit may correspond to a node and be associated with properties such as power consumption, received signal strength, received signal power, or the like. These properties are updated in the knowledge graph 206 by the model 208. In another example, a node may represent a user equipment and be associated with properties such as throughput and signal quality. A node may represent a distributed unit and be associated with properties such as processor usage, packet error rates, latency, and the like.

The telemetry data 220 received or collected from the network 212 is used by the model 208 to update the knowledge graph 206. Thus, the knowledge graph 206 represents a current state of the network 212 and is regularly or continually updated to account for changes that occur in the network 212. In other words, the knowledge graph 206 represents the components or units in the network 212 and the associated values or properties.

This knowledge graph 206 can inform policy generation. For example, a policy intent 216 related to a performance degradation may be informed by the current conditions of the network via the knowledge graph 206. This allows any policy generated to account for current network conditions and state.

Thus, the policy generation engine 210 may query the knowledge graph 206 and the output of the query may be augmented with the imperative objective 218 received from the model 218. In this manner, the policy generation engine may generate a prompt to the model 214 that includes or represents the imperative objective 218 and a current state of the network 212 or portion thereof reflected in the result of the query to the knowledge graph 206. The knowledge graph may be queried in a manner that may be guided by metadata associated with the imperative objective 218 (e.g., location).

The policy generation engine 210, once the imperative objective 218 and the result of querying the knowledge graph 206 are obtained, queries a model 214, which also receives telemetry data 220 of the network 212. In effect, the model 214 is prompted with a prompt that includes the imperative objective 218 and data from the knowledge graph 206.

The model 214 is configured to generate a decision (e.g., generate a recommended policy or updated policy) for implementation in the network 212. The model 214 may be trained on telemetry data, policy, the impact of policy on network operation as reflected in the telemetry data, or the like. This allows the model 214 to understand the relationships between policies and the functions and operations of the network 212. The model 214 can thus recommend a policy that reflects the policy intent 216 without causing inefficiencies or over limiting the performance of the network 212.

The recommended policy is returned to the policy generation engine 210 and the policy 222 is implemented in the network 212. In some examples, implementation of the policy 222 may be delayed or rejected by the policy generation engine 210. Further, the network operator 202 may be notified of the decision to implement, delay, or reject the policy 222 generated from the policy intent 216.

The knowledge graph 206 provides a structured and interconnected view of the network 202, and captures relationships and historical trends that help in understanding the broader context. The telemetry data 220 offers real-time, granular data that reflects the current state of the network. The model 214 benefits from the telemetry data 220 and the knowledge graph 206. In one example, the knowledge graph 206 and the telemetry data 220 ensure that the model 214 has structured and interconnected view of the network 202, including relationships and historical trends, and the telemetry data 220 helps ensure that decisions or policies recommended by the model 214 are based on the latest network conditions or state.

Policies generated by the policy generation engine 210 may include, by way of example and not limitation, traffic steering policies such as load balancing, quality of service policies such as bandwidth allocation and latency management. Examples of data stored in the knowledge graph 206 may include: Entity: Base Station (BS-101). Attributes of the base station may include: Location: “Tokyo”, Capacity: “1000 users”, Frequency Band: “3.5 GHz”

The knowledge graph 206 may also store data such as: Entity: User Device (Device—202). Attributes of the user device may include: Model: “Smartphone X”, OS: “Android”, Battery Level: “85%”

The knowledge graph 206 may also represent a relationship such as: Relationship: “Device—202 is connected to BS-101”.

The model 214 is configured to combine telemetry data 220 with the knowledge or data acquired from the knowledge graph 206. This integration allows the model 214 to have a comprehensive view of the current network state and historical trends. Using the combined data, the model 214 generates specific network policies. These policies are designed to address the current network conditions and operator policy intent.

For example, the network operator 202 may send a policy intent 216 to the model 204.. The policy intent 216 may be: “Ensure high-quality video streaming during peak hours.” The model 204 maps the policy intent 216 to an imperative objective 218 of: “Monitor network traffic every 5 minutes and allocate additional bandwidth to video streaming services during peak hours.”

The telemetry data 220 may reflect a sudden increase in network traffic in a specific area during peak hours. The knowledge graph 206 may indicate that this same specific area typically experiences high network traffic during certain times of the day and may include historical data on traffic patterns and resource utilization.

The model 214 may receive the real-time telemetry data 220 and query the knowledge graph 206 for relevant historical data and context. The model 214 may combine the real time telemetry data with the knowledge or data retrieved from the knowledge graph 206 and generate a policy that addresses the policy intent 216.

The generated police 222 may be: “Allocate an additional 20% bandwidth to video streaming services in the high-traffic area from 6 PM to 9 PM to ensure high-quality streaming.”

The policy 222 is transmitted or implemented in the network 212 to ensure that video streaming services receive the necessary resources during peak hours to maintain high quality.

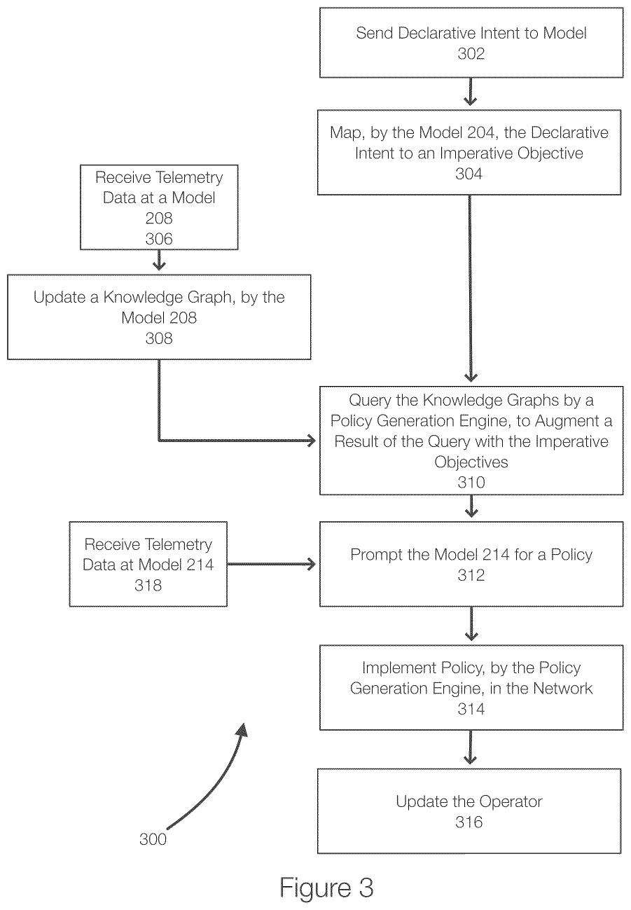

FIG. 3 discloses aspects of a method for generating and/or implementing policy in a network such as an O-RAN network. The method 300 may be performed by an RIC, such as the RIC 104. Further aspects of the method 300 are not necessarily performed in order or successively, but may occur concurrently or continually.

The method 300 may include sending 302 a declarative intent (policy intent) to a model (e.g., the model 204) of an RIC. The model 204 is trained or configured to map 304 or convert the policy intent to an imperative objective.

In the method 300, telemetry data of the network is received 306 at the model 208 and is received 318 at the model 214. The knowledge graph is updated 308 by the model 208 using the telemetry data received at the model 208. The telemetry data is continually or repeatedly provided to the models 208 and 214.

In this example of the method 300, the policy generation engine queries 310 the knowledge graph and augments the result of the query with the imperative objectives. Data from the knowledge graph and the imperative objects are used to prompt 312 the model 214 for a policy or a policy recommendation. The model 214 also receives 318 the telemetry data.

The model 214 generates a policy, which is implemented 314 in the network. Alternatively, the implementation of the policy may be delayed, cancelled, or the like. For example, the model 214 may recommend waiting until a certain condition is satisfied (e.g., latency is reduced to a particular level) prior to implementing the policy. Optionally, the operator or agent is updated 316 regarding the policy and status of the policy.

Returning to FIG. 2, the model 214 can provide an informed recommendation at least because the model is trained on telemetry data, historical policies, and other historical data of the network 212. As a result, the training represents inter-dependencies among the network components. Policies generated by the model 214 thus account for the impact of the policies on the network as a whole rather, for example, a policy for a specific device that is not performing adequately. Stated differently, policies generated or recommended by the model 214 are context-aware.

Embodiments of the invention provide an evolving knowledge graph that ingests data on network conditions and user behavior. Thus, the knowledge graph is updated dynamically.

In one example, RIC 200 is configured to refine telemetry data and updates to the knowledge graph into policy.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, policy generation operations, policy intent mapping operations, knowledge graph related operations, context aware policy generation and/or implementation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. Further, the AFMs may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. In a network, a method for managing policies of the network, the method comprising: receiving a policy intent at a first model configured to map the policy intent to an imperative objective, retrieving network data from a knowledge graph, wherein the knowledge graph is updated by a second model using telemetry data of the network, prompting a third model with the network data retrieved from the knowledge graph and the imperative objective to generate a recommended policy, receiving the recommended policy from the third model, and implementing the recommended policy in the network.

Embodiment 2. The method of embodiment 1, wherein the policy intent is expressed in natural language and the network comprises a radio access network or an open radio access network, wherein the policy intent specifies a policy without detailing operations to achieve the policy in the network and wherein the imperative objective includes operations to perform to achieve the policy in the network.

Embodiment 3. The method of embodiment 1 and/or 2, wherein the first model is an agentic foundation model or a large language model, the second model is an agentic foundation model or a large language model, and the third model is an agentic foundation model or a large language model.

Embodiment 4. The method of embodiment 1, 2, and/or 3, wherein the second model is configured to receive telemetry data of the network.

Embodiment 5. The method of embodiment 1, 2, 3, and/or 4, wherein the knowledge graph represents a state of the network based on most recent telemetry data, wherein the knowledge graph is regularly or continually updated by the second model.

Embodiment 6. The method of embodiment 1, 2, 3, 4, and/or 5, where the third model is configured to receive the telemetry data.

Embodiment 7. The method of embodiment 1, 2, 3, 4, 5, and/or 6, wherein the third model is configured to generate the recommended policy based in part on the telemetry data received from the network.

Embodiment 8. The method of embodiment 1, 2, 3, 4, 5, 6, and/or 7, further comprising delaying the recommended policy by an agent.

Embodiment 9. The method of embodiment 1, 2, 3, 4, 5, 6, 7, and/or 8, further comprising rejecting the recommended policy by an agent.

Embodiment 10. The method of embodiment 1, 2, 3, 4, 5, 6, 7, 8, and/or 9, wherein the recommended policy is generated in anticipation of an event, wherein the event is one of an event occurring in an environment, a scheduled update to the network, an upgrade to the network, or maintenance of the network.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

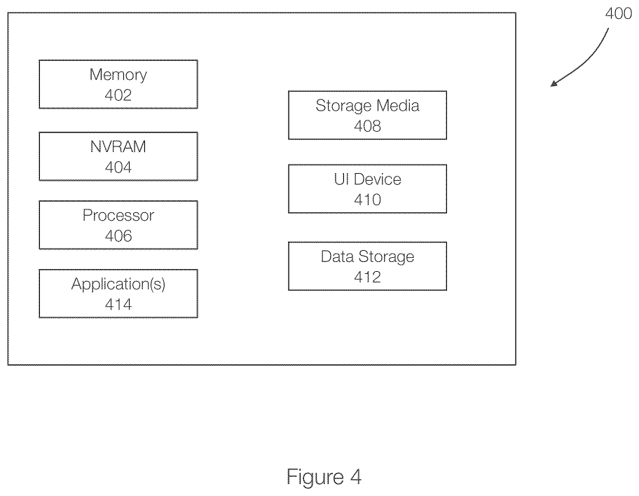

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods illustrated in the Figures.

The device 400 may represent a cloud-based system, an edge-based, system, an on-premise system, or combinations thereof. Document understanding and related operations may be performed using these types of computing environments/systems.

IN one example, the RIC may be integrated with the network, may be implemented using servers, clusters, or the like. The RIC may include distributed components. Data input to the models may be sourced from multiple locations and multiple models may be used in parallel.

The described embodiments are to be considered in all respects only as illustrative and not restrictive. All changes which come within the meaning and range of equivalency of the claims are to be embraced within their scope.

What is claimed is:

1. In a network, a method for managing policies of the network, the method comprising:
receiving a policy intent at a first model configured to map the policy intent to an imperative objective;
retrieving network data from a knowledge graph, wherein the knowledge graph is updated by a second model using telemetry data of the network;
prompting a third model with the network data retrieved from the knowledge graph and the imperative objective to generate a recommended policy;
receiving the recommended policy from the third model; and
implementing the recommended policy in the network.

2. The method of claim 1, wherein the policy intent is expressed in natural language and the network comprises a radio access network or an open radio access network, wherein the policy intent specifies a policy without detailing operations to achieve the policy in the network and wherein the imperative objective includes operations to perform to achieve the policy in the network.

3. The method of claim 1, wherein the first model is an agentic foundation model or a large language model, the second model is an agentic foundation model or a large language model, and the third model is an agentic foundation model or a large language model.

4. The method of claim 1, wherein the second model is configured to receive telemetry data of the network.

5. The method of claim 4, wherein the knowledge graph represents a state of the network based on most recent telemetry data, wherein the knowledge graph is regularly or continually updated by the second model.

6. The method of claim 4, where the third model is configured to receive the telemetry data.

7. The method of claim 6, wherein the third model is configured to generate the recommended policy based in part on the telemetry data received from the network.

8. The method of claim 7, further comprising delaying the recommended policy by an agent.

9. The method of claim 7, further comprising rejecting the recommended policy by an agent.

10. The method of claim 1, wherein the recommended policy is generated in anticipation of an event, wherein the event is one of an event occurring in an environment, a scheduled update to the network, an upgrade to the network, or maintenance of the network.

11. A non-transitory storage medium having stored therein instructions that are executable by one or more hardware processors to perform operations comprising:
receiving a policy intent at a first model configured to map the policy intent to an imperative objective;
retrieving network data from a knowledge graph, wherein the knowledge graph is updated by a second model using telemetry data of the network;
prompting a third model with the network data retrieved from the knowledge graph and the imperative objective to generate a recommended policy;
receiving the recommended policy from the third model; and
implementing the recommended policy in the network.

12. The non-transitory storage medium of claim 11, wherein the policy intent is expressed in natural language and the network comprises a radio access network or an open radio access network, wherein the policy intent specifies a policy without detailing operations to achieve the policy in the network and wherein the imperative objective includes operations to perform to achieve the policy in the network.

13. The non-transitory storage medium of claim 11, wherein the first model is an agentic foundation model or a large language model, the second model is an agentic foundation model or a large language model, and the third model is an agentic foundation model or a large language model.

14. The non-transitory storage medium of claim 11, wherein the second model is configured to receive telemetry data of the network.

15. The non-transitory storage medium of claim 14, wherein the knowledge graph represents a state of the network based on most recent telemetry data, wherein the knowledge graph is regularly or continually updated by the second model.

16. The non-transitory storage medium of claim 14, where the third model is configured to receive the telemetry data.

17. The non-transitory storage medium of claim 16, wherein the third model is configured to generate the recommended policy based in part on the telemetry data received from the network.

18. The non-transitory storage medium of claim 17, further comprising delaying the recommended policy by an agent.

19. The non-transitory storage medium of claim 17, further comprising rejecting the recommended policy by an agent.

20. The non-transitory storage medium of claim 11, wherein the recommended policy is generated in anticipation of an event, wherein the event is one of an event occurring in an environment, a scheduled update to the network, an upgrade to the network, or maintenance of the network.
